(19) United States
(12) Patent Application Publication
(10) Pub. No.: US 2009/0044450 A1
(43) Pub. Date: Feb. 19, 2009

(54) INTEGRATED SAFETY GATE

(76) Inventor: Marie A. Hallman, Walled Lake, MI (US)

Correspondence Address: MYERS DAWES ANDRAS & SHERMAN, LLP, 19900 MACARTHUR BLVD., SUITE 1150, IRVINE, CA, 92612, US

(21) Appl. No.: 12/192,411

(22) Filed: Aug. 15, 2008

Related U.S. Application Data
(60) Provisional application No. 60/956,641, filed on Aug. 17, 2007.

(51) Int. Cl. E06B 7/28

(52) U.S. Cl. 49/50; 49/506

(57) ABSTRACT

The invention provides a method of using an integrated safety gate and an integrated safety gate. The integrated safety gate includes a housing including a face, a folding gate connected to the housing, the folding gate is configured to be stowed in the housing, and a latch housing positioned opposite to the housing, the latch housing is configured to removably connect with the folding gate.

### BACKGROUND OF THE INVENTION

1. Field of the Invention

The present invention relates generally to safety gates, and in particular to an integrated safety gate.

2. Background Information

Child protection or safety gates can protect children and pets from entering different areas. The known gates are typically a temporary gate that is pressed or deployed in a sliding way to wedge itself between two walls. Many of these are bulky and made of two portions that slide out and are locked with a clamp. These gates are typically not attractive and do not add to a rooms decor. When these gates are removed from the barrier, they are typically leaned against a wall or placed behind a door.

### SUMMARY OF THE INVENTION

The invention provides a method of using an integrated safety gate and an integrated safety gate. The integrated safety gate includes a housing including a face, a folding gate connected to the housing, the folding gate is configured to be stowed in the housing, and a latch housing positioned opposite to the housing, the latch housing is configured to removably connect with the folding gate.

Another embodiment of the invention provides a safety gate including a base housing configured to house a folding gate, and a face coupled to the folding gate, the face configured to removably couple with the base housing and a latch housing. The folding gate is configured to unfold and form a barrier.

Yet another embodiment of the invention provides a method for providing a safety gate. The method including opening a face coupled to a newel to locate a folding gate, removing the folding gate from the newel, and latching the folding gate to a latch housing to provide a safety gate.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 illustrates an integrated safety gate according to one embodiment of the invention;

FIG. 2 illustrates the integrated safety gate with a folding gate shown in a partially deployed (unfolded) state according to one embodiment of the invention;

FIG. 3 illustrates the integrated safety gate shown in a latched state according to one embodiment of the invention;

FIG. 4 illustrates a fully deployed integrated safety gate according to an embodiment of the invention;

FIG. 5 illustrates the integrated safety gate shown in a stowed state within the base housing which allows a child 510 to climb the staircase 120 according to one embodiment of the invention;

FIG. 6 illustrates the integrated safety gate preventing entrance to the staircase 120 by a child 510 according to one embodiment of the invention;

FIG. 7 illustrates an integrated safety gate shown in an open “swing gate” state according to an embodiment of the invention;

FIG. 8 illustrates an internal view of the integrated safety gate shown in a closed state;

FIG. 9 illustrates an internal view of the integrated safety gate shown in an open state; and

FIG. 10 illustrates a block diagram of a method of providing an integrated safety gate according to one embodiment of the invention.

### DESCRIPTION OF THE PREFERRED EMBODIMENTS

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments of an integrated safety gate, as well as operation and/or component parts thereof. While the following description will be described in terms of dental handpieces, it should be kept in mind that the teachings herein may have broad application to all types of systems, devices and applications.

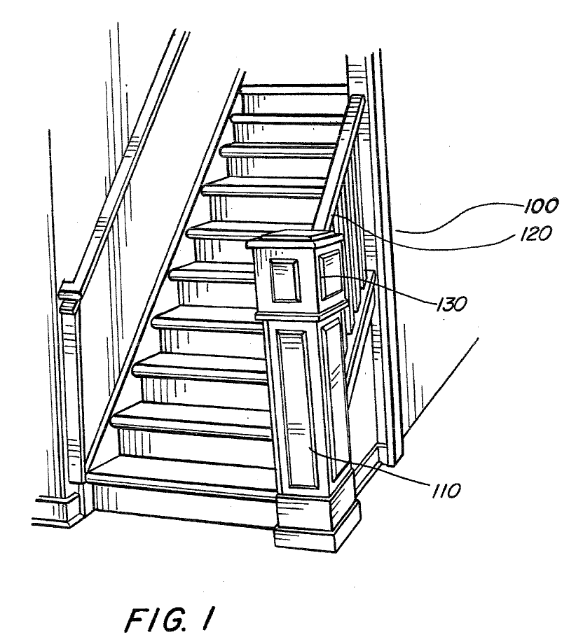

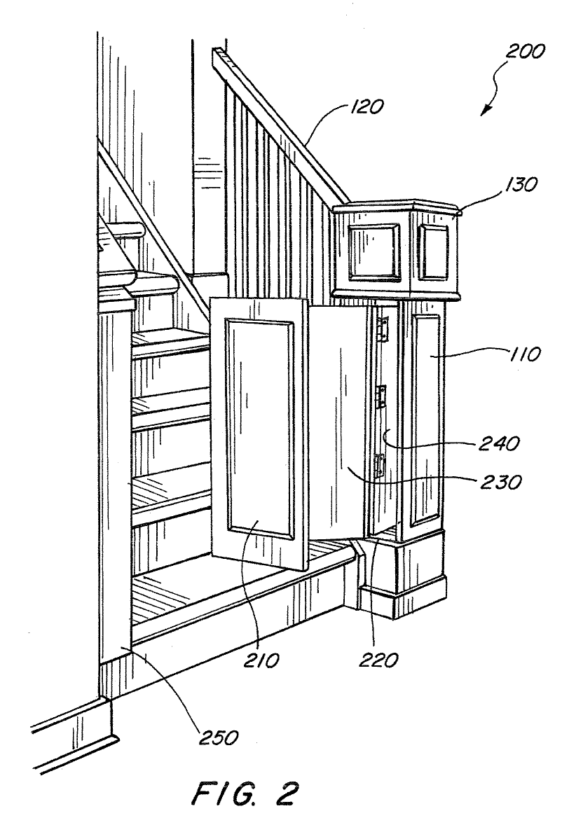

FIG. 1 illustrates an integrated safety gate 100 according to one embodiment of the invention. Integrated safety gate 100 includes a base housing (also known as a nevel) for a folding gate 230 (see FIG. 2). The base housing 110 is attached to a staircase 120. It should be noted that while FIG. 1 shows base housing 110 connected to the bottom of staircase 100, base housing 100 can also be connected to a top of staircase 120 in other embodiments. As illustrated, base housing 100 is shown in a state where the folding gate 230 is in a stowed position within base housing 110. In this state, folding gate 230 is hidden from sight.

In one embodiment of the invention, base housing 110 includes an upper portion 130. In one embodiment of the invention, upper portion 130 includes a door and includes a storage portion within itself. In this embodiment, different items can be hidden from view and stored, such as keys, latching items for the integrated safety gate 100, etc. In another embodiment, an alarm system connected to the integrated safety gate 100 is stored within upper portion 130. In this embodiment, when the integrated safety gate 100 is deployed, the alarm senses whether the integrated safety gate has been breached (i.e., opened, climbed over, etc.). If the alarm senses the integrated safety gate has been breached, then the alarm emits an audible sound (an alert sound, a voice, etc.).

FIG. 2 illustrates the integrated safety gate 100 shown with the folding gate 230 shown in a partially deployed (unfolded) state according to one embodiment of the invention. In this embodiment of the invention, folding gate 230 is connected to face portion 210 on its one end and an inner panel 240 on its other end. Face portion 210 is shown removed from base housing 110. In another embodiment, face portion 210 is connected to base housing 110 as a door, which is opened and the folding gate 230 can be deployed or stowed with opening the face portion 230 as a door.

In one embodiment a latching housing 250 is shown mounted on a wall. The latching housing 250 is configured to latch the face portion to prevent passage though the integrated safety gate 100 by children, pets, falling items when positioned on the top of a staircase, etc. In one embodiment of the invention, the integrated safety gate is made from wood. In other embodiments of the invention, integrated safety gate 100 main components are made of metal, a metal alloy, PVC, pressboard covered with veneers, etc. Additionally, as the base housing 110 is shown with a rectangular shape, the base housing 110 can be any shape, such as cylindrical, polygonal, oval, etc. In one embodiment of the invention, folding gate 230 can be a mesh material, chain, rolled material, etc. In this embodiment, face portion 210 is not connected to the folding gate 230. In one embodiment of the invention, when the face portion is not coupled to the folding gate 230, another panel is coupled to the folding gate 230, which has a length, height and width that is substantially the same as that of the opening of the latching housing 250.

The integrated safety gate 100 can be made to fit any size stairwell. In one embodiment of the invention, inner panel 240 has a first size that can be cut in order to adjust the length of the folding gate 230 in order to achieve a proper fit. Other panels of different sizes can also be added in order to provide a proper length of folding gate 230.

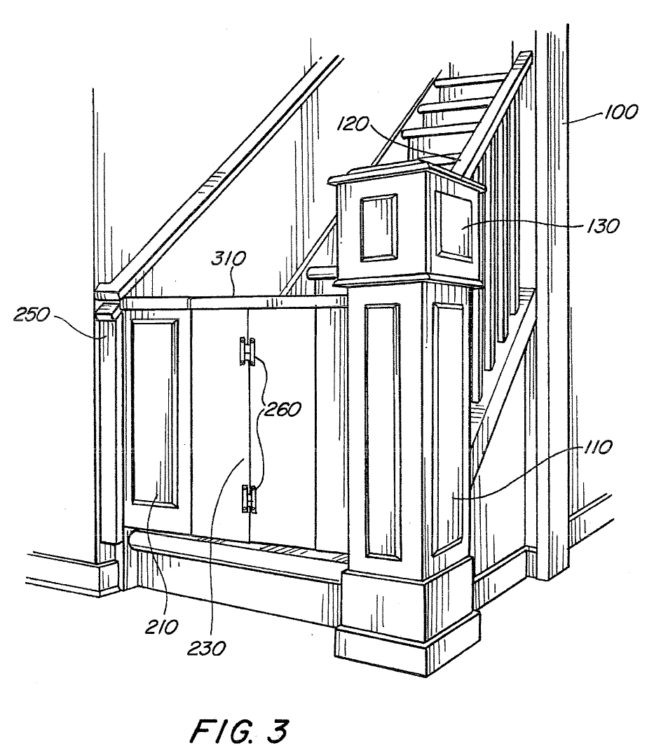

FIG. 3 illustrates the integrated safety gate 100 shown in a latched state with latch housing 250 according to one embodiment of the invention. In one embodiment of the invention, folding gate 230 includes at least two hinges between each panel and between face portion 210. It should be noted that more hinges can be added depending on the weight of the panels and face portion 210. In other embodiments, different placement and types of hinges can be used, such as hinges on the top and bottom of each panel.

In one embodiment of the invention, a locking bar 310 is placed over the top of folding panel 220 and face portion 210. In this embodiment, the locking bar 310 prevents the panels of folding panel 220 and face portion from folding. In one embodiment of the invention, the locking bar 310 has a bottom portion that when slid on the top portions of the panels that have a groove, locks the locking bar 310 in place. In another embodiment of the invention, locking bar 310 has means for latching to the top portions of the different panels. In one embodiment of the invention, the means for latching includes a key, one or more locking press release buttons, fits into slots on either end, is made of two or more sections with worm extensions to move the sections away from one another to lock the locking bar 310 against the latch housing 250, etc. In another embodiment of the invention, the locking bar 310 is positioned on the bottom of the folding gate 230 and face portion 210 panels. In yet another embodiment of the invention, other means for locking the panels of the integrated safety gate 100 are used, such as slide bolts, a locking bar on a swing arm that is attached to the first panel and swings down to a clamp or u-shaped member on the bottom of the last panel or face portion 210, clamps, etc. In one embodiment the locking bar 310 fits inside the base housing 110 when not in use.

In one embodiment of the invention, latch housing 250 includes either a metal or one or more magnets located on the right side wall that forms a magnetic coupling with magnets or metal on the back side edge of the face portion 210 on the edge facing the right side wall of the latch housing 250 when engaged. This magnetic coupling is strong enough to hold the face portion 210 securely to the latch housing 250.

In one embodiment of the invention a means for holding the folding gate 230 from shifting, rattling, etc. when stowed in the base housing 110 is included. The means for holding the folding gate 230 can be magnets, guard bar, hooks, clasps, springs, etc.

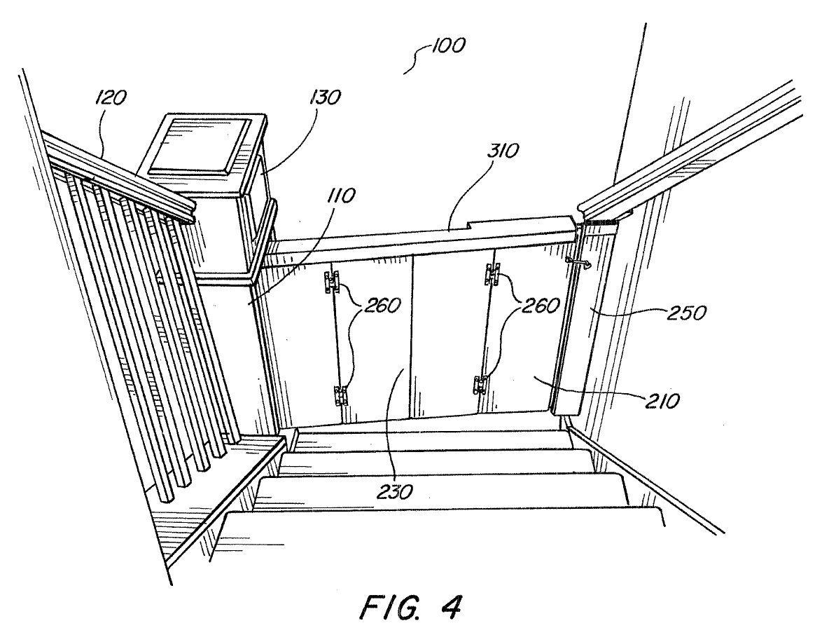

FIG. 4 illustrates a fully deployed integrated safety gate 100 according to an embodiment of the invention. In this embodiment of the invention, the integrated safety gate 100 is used as a swing door. That is, the folding gate 230 and the face portion 210 when coupled with the locking bar 310 forms a rigid door that swings out on hinges that connect the first panel of the folding gate 230 and inner panel 240. In one embodiment of the invention a simple latch 410 can keep the “swing door” latched. In another embodiment of the invention, a spring or hydraulic mechanism places force on the folding gate 230 and returns the folding gate 230 to a shut position (as shown) automatically. In other embodiments of the invention other latch or locking mechanisms can be used to maintain the folding gate 230 in a shut position.

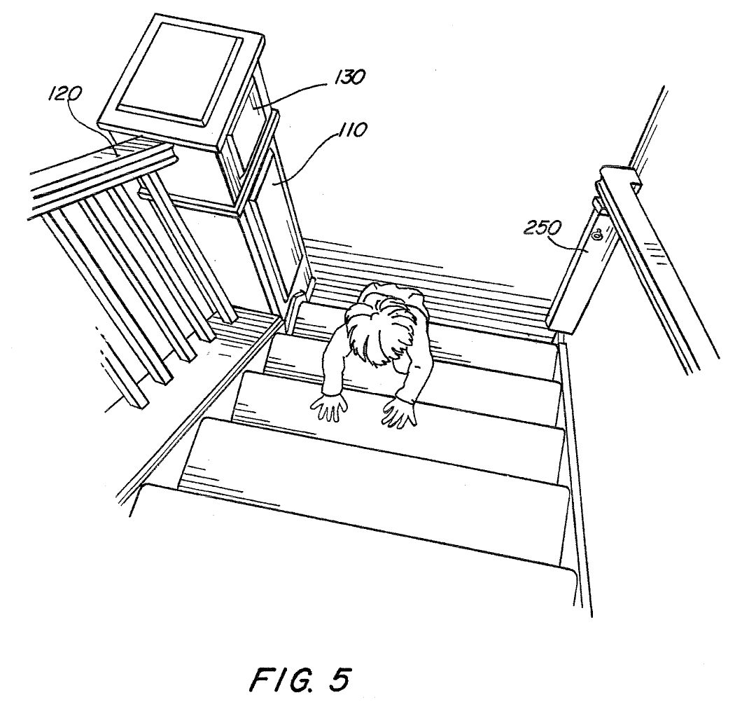

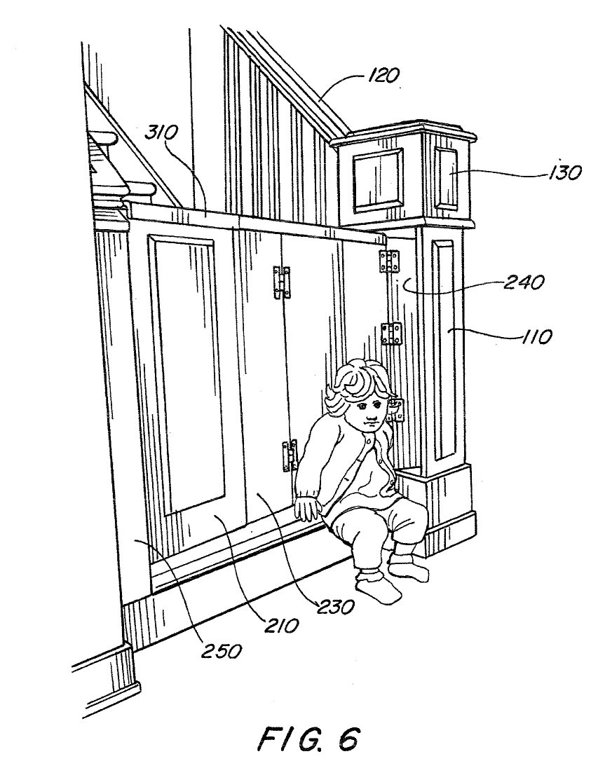

FIG. 5 illustrates the integrated safety gate 100 in a stowed state within base housing 110 according to one embodiment of the invention. As illustrated, the integrated safety gate 100 looks like an ordinary newel when in the stowed state. FIG. 6 illustrates the integrated safety gate 100 in a deployed state that prevents a child 510 from climbing the staircase 120 an according to one embodiment of the invention. In one embodiment of the invention, the integrated safety gate is positioned so that the folding gate 230, when deployed, allows access to the first step of the staircase 120. In other embodiments of the invention, the integrated safety gate is positioned so that access to the first step of the staircase 120 is blocked.

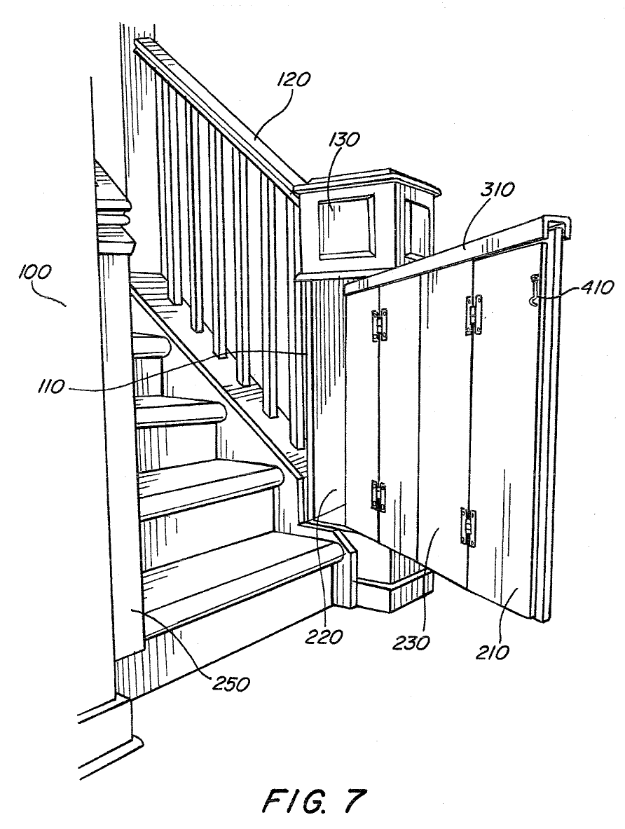

FIG. 7 illustrates the integrated safety gate 100 shown in a “swing door” state in an open position. In one embodiment of the invention a folding handle attached to the last panel of the folding gate 230. In other embodiments, instead of manually using the latch 410, a simple latch and bolt mechanism is used. In this embodiment, the bolt is attached to the back of face portion 210 and is rotated up and locked into place. The latch is attached to the latch housing 250. With the integrated safety gate 100 placed in the “swing gate” state, the integrated safety gate 100 is readily moved aside and can be deployed without having to remove locking bar 310 and folding the folding gate 230.

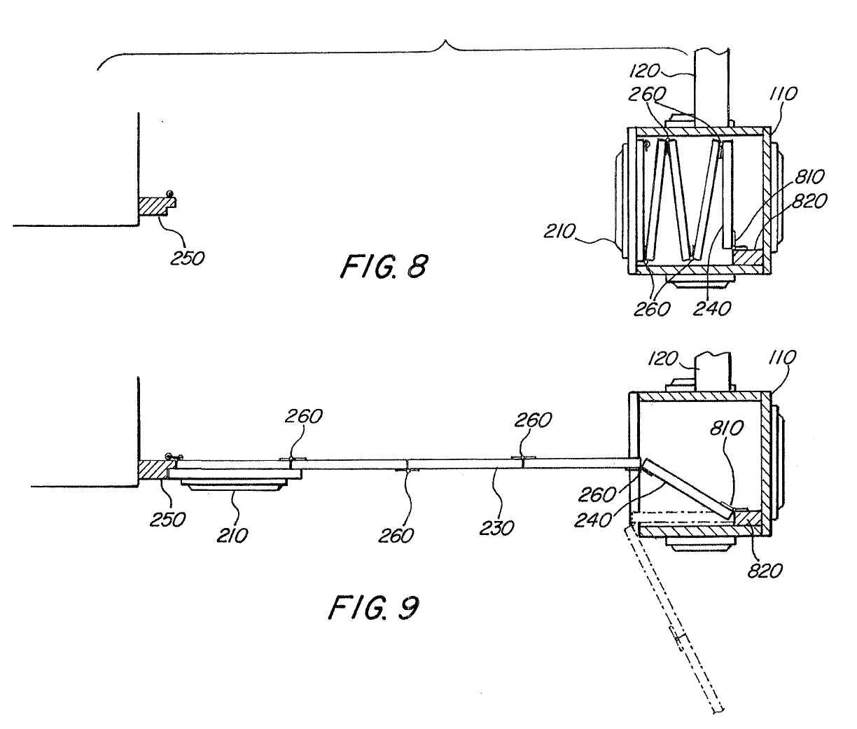

FIG. 8 illustrates a top internal view showing the integrated safety gate 100 shown in a closed state (i.e., folded). In one embodiment of the invention a rail 820 is hingedly connected to inner panel 240 with a hinge 810. As illustrated, the integrated safety gate 100 is folded in the closed state and is hidden from view inside base housing 110.

FIG. 9 illustrates a top internal view showing the integrated safety gate 100 shown in an opened state (i.e., deployed). As shown, in this opened state inner panel 240 is angled to allow the panels (230 and 210) to form the safety gate. Also illustrated is the position of inner panel 240 when the integrated safety gate 100 is used as a swing gate.

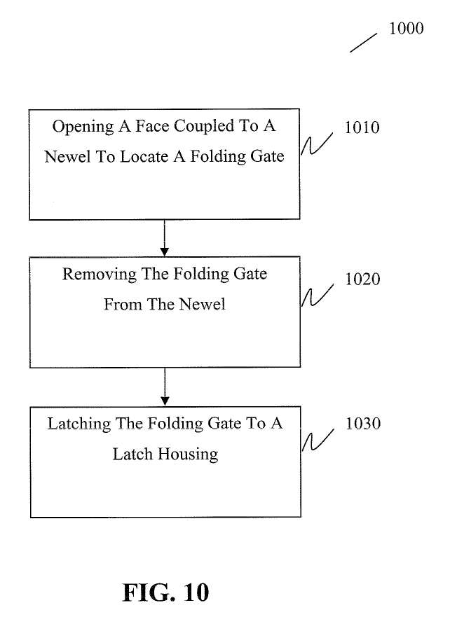

FIG. 10 illustrates a block diagram of a process 1000 for providing a safety gate according to an embodiment of the invention. Process 1000 begins with block 1010 where a face (e.g., face portion 210) that is coupled to a newel is opened to locate a folding gate within the newel. In one embodiment of the invention, the face is hinged to a base housing (e.g., base housing 110). In another embodiment, the face is attached to the folding gate with a hinge and is opened by pulling the face off the base housing.

In block 1020, the folding gate is removed from the newel. In this embodiment of the invention, the folding gate has many different panels in order to fit the particular location size to be blocked by the folding gate. The folding gate is removed by pulling the folding gate out from the newel. It should be noted that other means for deploying the folding gate can be used, such as a motor that receives a signal from a switch, remote control or home network device and deploys the folding gate automatically. In block 1030 the folding gate is latched to a latch housing, thus securing the folding gate and providing an integrated safety gate.

With the use of the embodiments of the invention, a safety gate can be deployed to protect small children, pets, etc. from climbing up/down staircases and also prevent items, from falling down a staircase. Some embodiments act like a swing door and make it easy to enter a gated area without a hassle.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A safety gate comprising:
a base housing configured to house a folding gate;
a face coupled to the folding gate, the face configured to removably couple with the base housing and a latch housing;
wherein the folding gate is configured to unfold and form a barrier.

2. The safety gate of claim 1, further comprising a locking bar configured to couple to the folding gate and the face in an unfolded state and to prevent folding of the folding gate and the face.

3. The safety gate of claim 2, wherein the locking bar couples to one of a top of the face and a top of the folding gate and a bottom of the face and a bottom of the folding gate.

4. The safety gate of claim 1, wherein the latch housing includes a means for latching a latch portion of the face.

5. The safety gate of claim 1, wherein the safety gate is configured to provide a swing gate barrier.

6. The safety gate of claim 1, wherein the base housing is a newel and is coupled to a stair rail.

7. The safety gate of claim 6, wherein the base housing is positioned at one of a top of a staircase and a bottom of a staircase.

8. The safety gate of claim 1, wherein the latch housing is one of mounted on a surface opposite the base housing and integrated in the surface.

9. An integrated safety gate, comprising:
a housing including a face;
a folding gate coupled to the housing, the folding gate configured to be stowed in the housing; and
a latch housing positioned opposite to the housing, the latch housing configured to removably couple with the folding gate.

10. The integrated safety gate of claim 9, wherein the face is hingedly coupled to the housing.

11. The integrated safety gate of claim 9, wherein the face is removably coupled to the housing.

12. The integrated safety gate of claim 11, wherein the face is coupled to the folding gate.

13. The integrated safety gate of claim 9, wherein a locking bar couples to one of a top of the folding gate and a bottom of the folding gate.

14. The integrated safety gate of claim 9, wherein the base housing is coupled to a stair rail.

15. The integrated safety gate of claim 14, wherein the base housing is a newel and is positioned at one of a top of a staircase and a bottom of a staircase.

16. The integrated safety gate of claim 1, wherein the safety gate is hidden from view when stored in the base housing.

17. A method for providing a safety gate, comprising:
opening a face coupled to a newel to locate a folding gate;
removing the folding gate from the newel; and
latching the folding gate to a latch housing to provide a safety gate.

18. The method of claim 17, wherein the face is a door of the newel.

19. The method of claim 17, further comprising:
attaching a locking device over one of a top portion of the folding gate and a bottom portion of the folding gate.

20. The method of claim 19, wherein the safety gate prevents passage to a staircase.
